(19) United States
(12) Patent Application Publication
(10) Pub. No.: US 2025/0308256 A1
(43) Pub. Date: Oct. 2, 2025

(54) TRACKING ROAD ELEMENTS IN AN ENVIRONMENT OF A VEHICLE

(71) Applicant: AUTOBRAINS TECHNOLOGIES LTD, Tel Aviv-Yafo (IL)

(72) Inventor: Adam HAREL, Tel Aviv (IL)

(73) Assignee: AUTOBRAINS TECHNOLOGIES LTD, Tel Aviv-Yafo (IL)

(21) Appl. No.: 18/624,057

(22) Filed: Apr. 1, 2024

(51) Int. Cl. G06V 20/56

(52) U.S. Cl. CPC G06V 20/588

(57) ABSTRACT

A method for monitoring road markings in an environment of a vehicle, the method includes (a) receiving by a processing circuit, information about the environment; (b) identifying, based on the information about the environment, a road marking that is located within the environment; and (c) applying an object-based approach, on the road marking using the identified information.

### BACKGROUND

Autonomous driving and various advanced driver assistance system (ADAS) functionalities require to detect road lanes located within an environment of a vehicle.

A known lane detection method includes approximating lane boundaries to curves that are represented by curve parameters—such as coefficients of a polynomial function. An example of a prior art lane detection method is illustrated in “Lane Detection and Tracking algorithm Based on Curve Fitting Model”, Rajakumar R., Pandian R., and PremJacob T., Smart Intelligent Computing and Communication Technology, doi:10.3233/APC210009.

A curved fitting algorithm may provide reasonable solutions while the lane boundary is sensed by a vehicle sensor.

It has been found that when the vehicle drives through a crowded road-especially when driving in heavy traffic—the lane boundary may not be sensed by the vehicle sensor for prolonged periods of time—and the curve fitting algorithm fails.

There is a growing need to provide a method for tracking lane boundaries.

### BRIEF DESCRIPTION OF THE DRAWINGS

The embodiments of the disclosure will be understood and appreciated more fully from the following detailed description, taken in conjunction with the drawings in which:

FIG. 1 illustrates an example of a method;

FIG. 2 illustrates an example of a method;

FIG. 3 illustrates an example of a vehicle;

FIG. 4 illustrates examples of images of an environment of a vehicle; and

FIG. 5 illustrates examples of images of an environment of a vehicle.

### DESCRIPTION OF EXAMPLE EMBODIMENTS

A road marking (also known as road surface marking) is used to convey official information such as but not limited to traffic regulations, alerts or requests or instructions related to driving or walking, and the like.

A road element is a portion of a road that is at least locally unique—it differs from at least a part of its local environment. According to an embodiment, a local environment is local in the sense that it is captured within a portion of a field of view (FOV) of a sensor of a vehicle. According to an embodiment a local environment has an area that may range between 0.5 to 20 square meters—but other area sizes are available. According to an embodiment, a road element is captured within a portion of a sensed information unit (SIU), whereas the portion may range between 1-20 percent of the SIU. A road marking is an example of a road element. Another example of a road element includes an obstacle, a road area that differs from its local surroundings (for example has a locally unique crack or locally unique combination of printed on content, a unique shape, and the like).

Some of the text refers to a lane boundary. Any reference to a lane boundary is applicable, mutatis mutandis, to any other road element. Some of the text refers to a road marking. Any reference to a road marking is applicable, mutatis mutandis, to any other road element

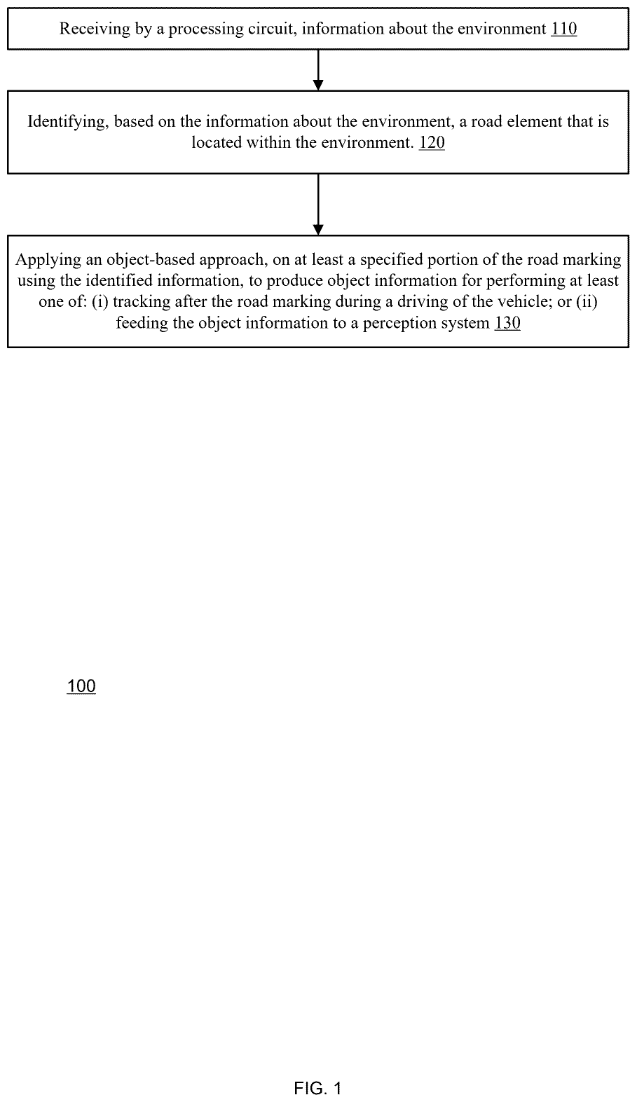

FIG. 1 illustrates an example of method 100 for monitoring a road element in an environment of a vehicle.

According to an embodiment, method 100 starts by step 110 of receiving by a processing circuit, information about the environment. According to an embodiment, the information is a sensed information unit (SIU). For simplicity of explanation it is assumed that the SIU is an image.

According to an embodiment, step 110 is followed by step 120 of identifying, based on the information about the environment, a road element that is located within the environment.

According to an embodiment, step 120 includes virtually segmenting the environment to environmental regions and analyzing content located within one or more of the environment regions to find the road element.

According to an embodiment, the analysis of the content is made per environment region.
According to an embodiment, the analysis related to an environment region includes defining the content of the entire environment region as a road element.
According to an embodiment, the analysis related to an environment region includes defining only a part of the environment region as a road element.
According to an embodiment, the analysis related to an environment region includes defining only a road element of a known type (that is within the environmental region) as the road element. What amounts to a known type of a road element can be learnt in various manners-such as receiving information about road elements (images and/or text defining the road elements, road element metadata and the like).

According to an embodiment, the analysis include assigning road element metadata that is related to the road element.

According to an embodiment, the road element metadata includes at least one of:
Location of the road element.
Descriptive information related to the road element.
Identifier of the road element.
Movement information. According to an embodiment the movement information includes at least one road element movement attribute. A road element movement attribute is determined based on a relative vehicle movement towards the road element. A road element movement attribute may be a relative speed and/or a relative acceleration. For example—assuming that the vehicle is headed directly towards the road element at a velocity of 50 kmh—then the movement information of the road element may include a speed attribute indicating that the road element moved directly towards the vehicle at a velocity of 50 kmh.

According to an embodiment, the descriptive information related to the road element include at least one of:
Descriptive information regarding a shape and/or size of the road element.
Class of the road element. For example—lane border, line type (broken line, single line, double line, solid line, dashed line, zebra crossing, arrow, text (may be which text—for example STOP, or SLOW, or NO ENTRANCE, a definition of a speed limit, or any other text), and the like.

According to an embodiment—when there are road element segments that span over different environment regions—each road element segment is treated as an independent road element. For example—the virtual segmentation of the environment also segments a lane boundary that spans over the different environment regions to lane boundary segments—and each lane boundary segment is treated as a road element.

According to an embodiment, step 120 includes defining the road element as a key-point.

The definition of the road element as a key-point includes associating with the road element road element metadata. According to an embodiment, the association is made without virtually segmenting the environment to environmental regions.

According to an embodiment, step 120 is followed by step 130 of applying an object-based approach, on at least a specified portion of the road marking using the identified information, to produce object information for performing at least one of: (i) tracking after the road marking during a driving of the vehicle; or (ii) feeding the object information to a perception system.

For simplicity of explanation some of the following example swill refer to the tracking after the road marking.

For example—step 130 includes applying an object-based approach, on the road element using the identified information, for tracking after the road element during a driving of the vehicle.

According to an embodiment, the applying of the object-based approach includes applying any object tracking algorithm-especially, applying a tracking algorithm that takes into account movement information related to the road element. Movement information-illustrated a velocity and/or acceleration of the road element and/or a relative acceleration and/or velocity in relation to the ego vehicle.

According to an embodiment, step 130 includes estimating, using the object-based approach, a location of the road element in the environment when the road element is temporarily concealed from a perspective of the vehicle.

According to an embodiment, step 130 includes estimating the location of the road element based in road element metadata obtained before the road element got temporarily concealed.

According to an embodiment, step 130 is also responsive to any change in a movement information of the vehicle—and changing the movement information of the road element accordingly.

According to an embodiment, step 130 continues while the road element is concealed. Once the road mapping ends to be concealed—step 130 resumes the tracking after the road element.

According to an embodiment, method 100 includes tracking the tracking after the road element during a driving of the vehicle.

According to an embodiment, the tracking is followed by responding to the outcome of the tracking.

According to an embodiment, method 100 or at least steps 110, 120 and 130 are executed before reaching the road element.

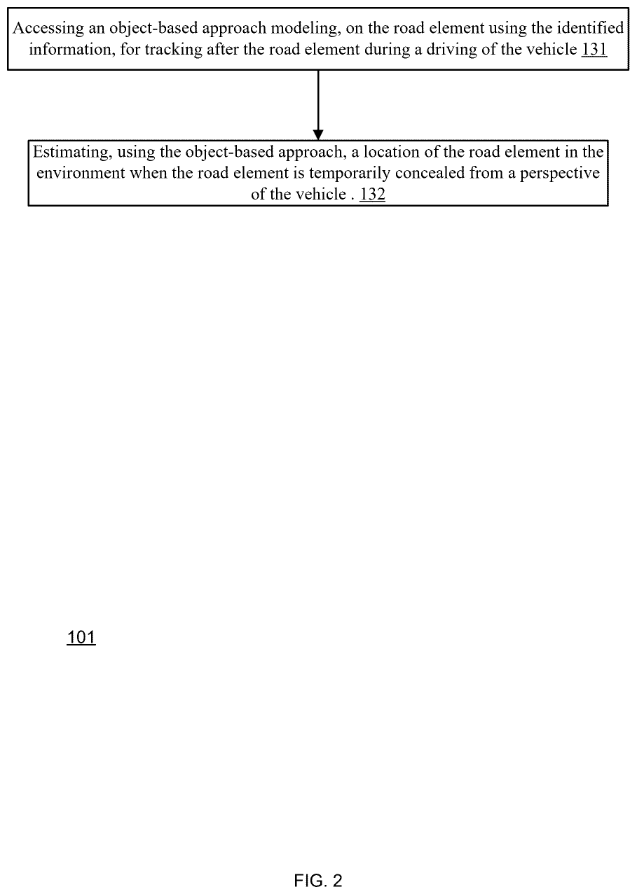

FIG. 2 illustrates an example of method 101.

According to an embodiment, method 101 includes step 131 of accessing an object-based approach modeling, on the road element using the identified information, for tracking after the road element during a driving of the vehicle. According to an embodiment, step 131 uses a model generated by or used during step 130.

According to an embodiment, the applying of the object-based approach include applying any object tracking algorithm-especially, applying a tracking algorithm that takes into account movement information related to the road element.

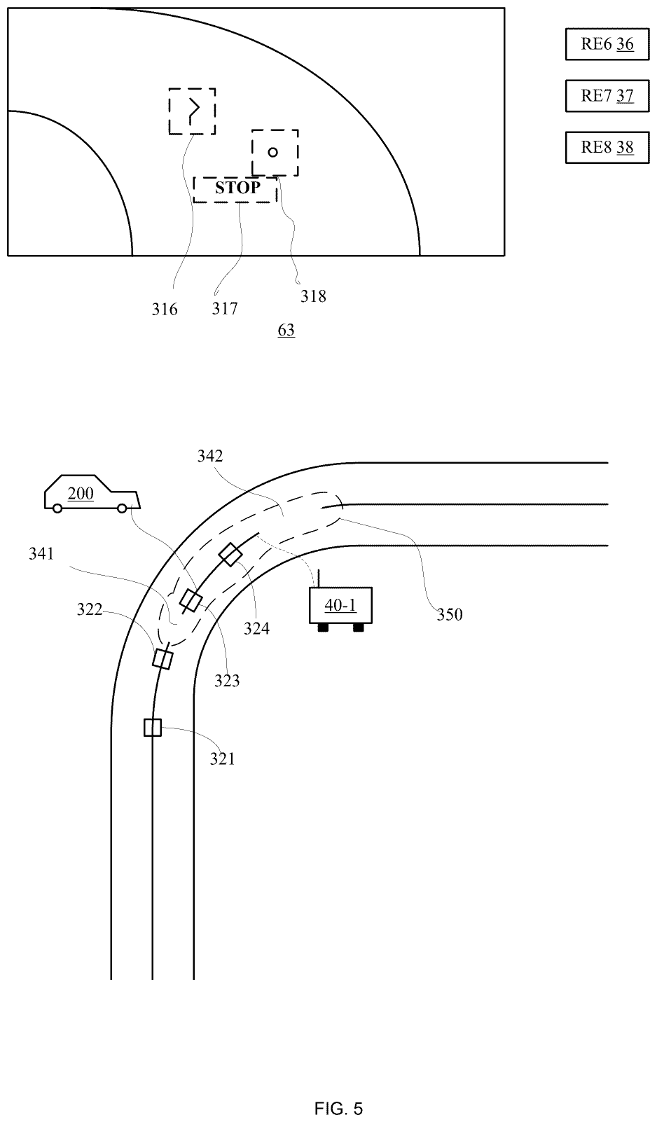

According to an embodiment, step 131 is followed by step 132 of estimating, using the object-based approach, a location of the road marking in the environment when the road marking is temporarily concealed from a perspective of the vehicle. See, for example, FIG. 5.

According to an embodiment, method 100 and/or method 101 step 140 include tracking and/or responding to the outcome of the tracking.

According to an embodiment, the response to the outcome of the tracking includes at least one of the following:
Producing a human-interpretable explainable representation of the road element.
Triggering a generation of a human-interpretable explainable representation of the road element.
Producing a machine-interpretable explainable representation of the road element.
Triggering a generation of a machine-interpretable explainable representation of the road element.
Triggering a determination of an autonomous driving related operation that is responsive to the road element.
Determining an autonomous driving related operation that is responsive to the road element.
Performing an autonomous driving related operation that is responsive to the road element.
Requesting from another vehicle unit to execute an autonomous driving related operation that is responsive to the road element.
Instructing another vehicle unit to execute an autonomous driving related operation that is responsive to the road element.
Generating a representation of one or more lane or road boundaries segments.
Sending the object information to a perception system.

According to an embodiment, the perception system is configured to analyze at least the information about the environment and response by requesting and/or instructing a determining of a driving related operation and/or by triggering a determination of the driving related operation. The driving related operation being an autonomous driving of a vehicle, an autonomous operation (such as an emergency breaking) of the vehicle or another ADAS operation.

According to an embodiment, the one or more lane or road boundaries segments extend beyond the one or more tracked road elements. A lane or road boundary segment may extend after any one of the one or more tracked road elements or may be located between two tracked road elements, and the like.

According to an embodiment, the generating of the representation of one or more lane or road boundaries segments includes determining a curve and generating a representation of the curve even when one or more segments of the curve are net sensed by the vehicle and/or even when one or more segments of the curve were already passed by the vehicle.

According to an embodiment, the generating of the representation of one or more lane or road boundaries segments takes into account at least one road element that was passed by the vehicle. In this case the at least road element is not currently sensed by the vehicle.

Taking into account road elements not currently seen by the vehicle increase the accuracy of the representation.

According to an embodiment, the generating of the representation of one or more lane or road boundaries segments includes generating a representation that is a polynomial.

According to an embodiment, method 100 is executed tens of times per second (for example between 10 and 120 times per second—even when the image includes hundreds of thousands (and even millions) of pixels—which is required for impacting driving decisions.

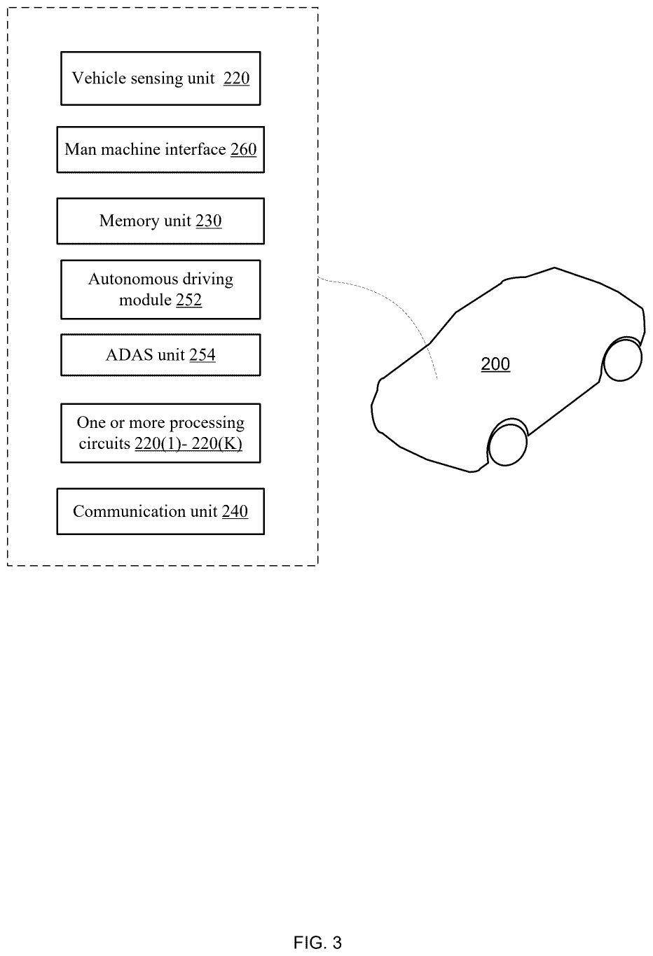

FIG. 3 illustrates an example of vehicle 200.

Vehicle 200 is illustrated as including:
A vehicle sensing unit 210 that may include one or more sensors such as visual and/or non-visual sensors.
One or more processing circuits denoted 220(1)-220(K) that are configured to execute method 100.
Memory unit 230.
Communication unit 240. The communication unit 440 may include an input and/or an output. The communication unit 440 may communicate with any entity—within the vehicle (for example driver device, passenger device, multimedia device), outside the vehicle (another vehicle, another computerized system, another road user, another human outside the vehicle), and the like.
One or more vehicle units such as one or more vehicle computers, units controlled by the one or more vehicle units, motor units, chassis, wheels, and the like. FIG. 3 illustrates one or more vehicle units that are an autonomous driving unit 252 and an ADAS unit 254.
Man machine interface 260.

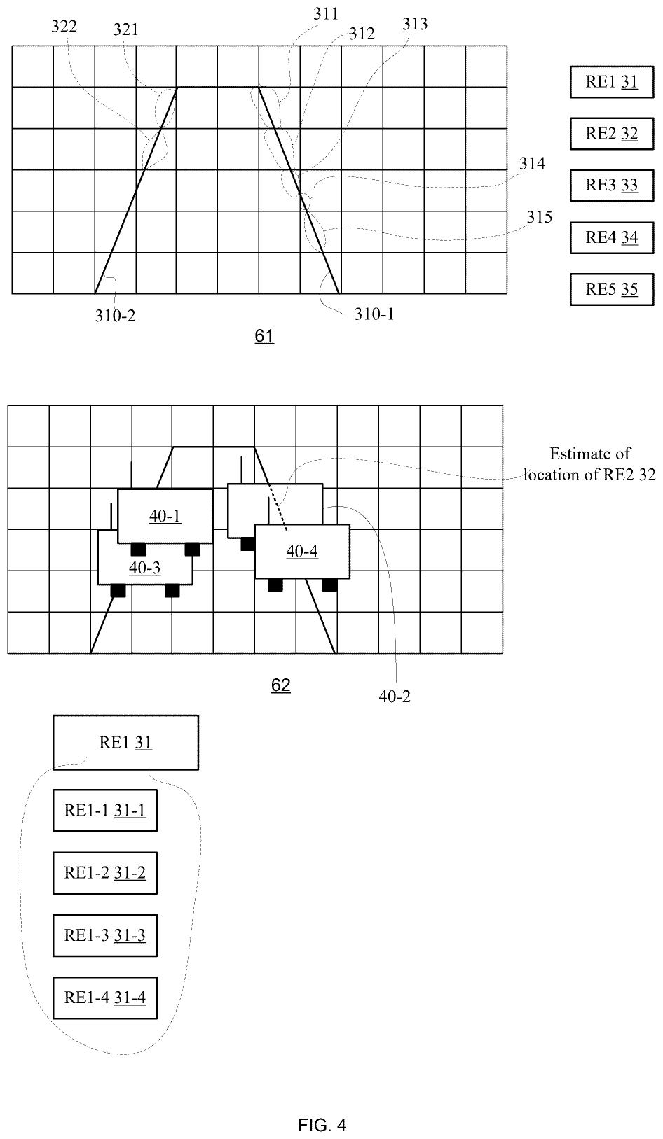

FIG. 4 illustrates two virtually segmented images 61 and 62 taken at two different points in time.

In image 61 there are a first lane boundary 310-1 and a second lane boundary 310-2 are both seen by the sensing unit of the vehicle and first segmented image 61 is virtually segmented to six lane boundary segments-some of which are denoted 311-315 and 321-322.

Five lane boundary segments 311-315 are defined as five road elements and are associated with road element metadata RE1-RE5 31-35, respectively. FIG. 3 also illustrates that road element metadata RE 1 includes location of road element RE1-1 31-1, descriptive information related to the road element RE-1-2 31-2, identifier of the road element RE-1-3 31-3, and movement information RE-1-4 31-4.

In image 62 some segments of the lane boundaries (such a lane boundary segments 312, 312, 314 and 322) are obscured by vehicles 40-1, 40-2, 40-3 and 40-4.

By applying method 100, the location of these lane boundaries is estimated. See, for example the estimate (represented by a dashed line) of lane boundary segment 312.

FIG. 5 illustrates an image 63 and a scenario.

The upper part of FIG. 5 illustrated image 63 of a portion of a curve that includes a first road element 316 that includes a road area with a locally unique crack (the first road element 316 is represented by road element metadata RE6 36), a second road element 317 that includes another road area with a locally unique hole (the second road element 317 is represented by road element metadata RE7 37), and a third road element 318 that includes a further road area with a locally unique road marking “STOP” (the third road element 318 is represented by road element metadata RE8 38).

The lower part of FIG. 5 illustrates a scenario that illustrates vehicle 200, obscuring vehicle 40-1, and a road that includes a curve.

Vehicle 200 precedes road elements 321, 323 and 323 and follows road element 324. Road elements 322, 323 and 324 are located within the curve.

Obscuring vehicle 40-1 obscured curve segment 342.

In order to determine the obscured curve segment 342 and even to determine a larger segment 350 of the curve (includes obscured curve segment), vehicle 200 bases the determination on, at least, road element 324 and at least one of road elements 323, 322 and 321.

There may be provided any tradeoff between the computational complexity of the determination and the accuracy of the determination. For example—the determination may be based on road elements 321-324 or on 232-324, and the like.

According to an embodiment, the determination includes taking into account previous estimations—for example, when vehicle reaches road element 323—the vehicle is already generated an estimate of the curve—and when estimating larger segment 350 the vehicle may take into account the previously generate estimate.

In the foregoing detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device or system capable of executing the method and/or to a non-transitory computer readable medium that stores instructions for executing the method.

Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

Any combination of any module or unit listed in any of the figures, any part of the specification and/or any claims may be provided.

The vehicle may be any type of vehicle that a ground transportation vehicle, an airborne vehicle, and a water vessel.

The specification and/or drawings may refer to a processor. The processor may be a processing circuitry. The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

The specification and/or drawings may refer to an image. An image is an example of a media unit. Any reference to an image may be applied mutatis mutandis to a media unit. A media unit may be an example of sensed information. Any reference to a media unit may be applied mutatis mutandis to any type of natural signal such as but not limited to signal generated by nature, signal representing human behavior, signal representing operations related to the stock market, a medical signal, financial series, geodetic signals, geophysical, chemical, molecular, textual and numerical signals, time series, and the like. Any reference to a media unit may be applied mutatis mutandis to sensed information. The sensed information may be of any kind and may be sensed by any type of sensors-such as a visual light camera, an audio sensor, a sensor that may sense infrared, radar imagery, ultrasound, electro-optics, radiography, LIDAR (light detection and ranging), etc. The sensing may include generating samples (for example, pixel, audio signals) that represent the signal that was transmitted, or otherwise reach the sensor.

Any reference to a cluster should be applied mutatis mutandis to a cluster structure. A concept structure may include one or more clusters. Each cluster may include signatures and related metadata.

Any reference to obtaining a content may include receiving the content, generating the content, participating in a processing of the content, processing only a part of the content and/or receiving only another part of the content. Examples of content include one or more signatures, an SIU and the like.

The obtaining of the content include object detection or may be executed without performing object detection.

Any combination of any steps of any method illustrated in the specification and/or drawings may be provided.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Rather the scope of the embodiments of the disclosure is defined by the appended claims and equivalents thereof.

What is claimed is:

1. A method that is computer implemented and is for monitoring road markings in an environment of a vehicle, the method comprises:
receiving by a processing circuit, information about the environment;
identifying, based on the information about the environment, a road marking that is located within the environment; and
applying an object-based approach, on at least a specified portion of the road marking using the identified information, to produce object information for performing at least one of:
tracking after the road marking during a driving of the vehicle; or
feeding the object information to a perception system.

2. The method according to claim 1, comprising determining that the road marking is a road object.

3. The method according to claim 1, wherein the identifying comprises virtually segmenting the environment to environmental regions and analyzing content located within one or more of the environment regions.

4. The method according to claim 1, wherein the identifying comprises defining the road marking as a key-point.

5. The method according to claim 1, wherein the road marking is a segment of a lane.

6. The method according to claim 1, further comprising producing a human of a machine interpretable explainable representation of the object information.

7. The method according to claim 1, further comprising estimating, using the object-based approach, a location of the road marking in the environment when the road marking is temporarily concealed from a perspective of the vehicle.

8. The method according to claim 1, wherein the applying of the object-based approach comprises associating a road marking movement attribute with the road marking, the road marking movement attribute is determined based on a relative vehicle movement towards the road marking.

9. The method according to claim 8, wherein the road marking movement attribute is a virtual speed of the road marking movement attribute

10. The method according to claim 1, comprising responding to an outcome of the tracking.

11. A non-transitory computer readable medium storing instructions that, when executed by at least one processor, cause the at least one processor to perform operations for monitoring road markings in an environment of a vehicle, comprising:
receiving by a processing circuit, information about the environment;
identifying, based on the information about the environment, a road marking that is located within the environment; and
applying an object-based approach, on at least a specified portion of the road marking using the identified information, to produce object information for performing at least one of:
tracking after the road marking during a driving of the vehicle; or
feeding the object information to a perception system.

12. The non-transitory computer readable medium according to claim 11, that stores instructions for determining that the road marking is a road object.

13. The non-transitory computer readable medium according to claim 11, wherein the identifying comprises virtually segmenting the environment to environmental regions and analyzing content located within one or more of the environment regions.

14. The non-transitory computer readable medium according to claim 11, wherein the identifying comprises defining the road marking as a key-point.

15. The non-transitory computer readable medium according to claim 11, wherein the road marking is a segment of a lane.

16. The non-transitory computer readable medium according to claim 11, further that stores instructions for producing a human of a machine interpretable explainable representation of the object information.

17. The non-transitory computer readable medium according to claim 11, further that stores instructions for estimating, using the object-based approach, a location of the road marking in the environment when the road marking is temporarily concealed from a perspective of the vehicle.

18. The non-transitory computer readable medium according to claim 11, wherein the applying of the object-based approach comprises associating a road marking movement attribute with the road marking, the road marking movement attribute is determined based on a relative vehicle movement towards the road marking.

19. The non-transitory computer readable medium according to claim 18, wherein the road marking movement attribute is a virtual speed of the road marking movement attribute.

20. The non-transitory computer readable medium according to claim 11, that stores instructions for responding to an outcome of the tracking.
